(19) United States
(12) Patent Application Publication
(10) Pub. No.: US 2005/0100484 A1
(43) Pub. Date: May 12, 2005

(54) Microreactor

(76) Inventors: Frank Arndt, Berlin (DE); Hendrik Ronsch, Berlin (DE); Arno Steckenborn, Berlin (DE)

Correspondence Address: YOUNG & THOMPSON, 745 SOUTH 23RD STREET, 2ND FLOOR, ARLINGTON, VA, 22202, US

(21) Appl. No.: 10/651,968

(22) Filed: Sep. 2, 2003

(30) Foreign Application Priority Data
Sep. 2, 2002 (DE) 10241093.3

(51) Int. Cl. B01J 19/00

(52) U.S. Cl. 422/130

(57) ABSTRACT

A microreactor in which interaction partners (14) are immobilized on the reactor wall (15) and a catalyst (21) is bound to these interaction partners. The catalyst (21) is preferably bound to the interaction partners (14) by hybridization of corresponding oligonucleotides. Furthermore, catalyst particles (21) which can be attached to fixed interaction partners (14) by a coupling-on partner (23) provided for this purpose are disclosed. The microreactor is suitable and advantageous for flexible use since a multiplicity of different catalyst particles can be attached to the tube walls of the reaction space (12) without any great difficulty. These compounds can be detached again, so that the microreactor can be used in succession for different reactions. The microreactor is suitable, for upstream processing of a bioprocess.

The invention relates to a microreactor having a reaction space for a fluid comprising at least one reactant.

Such a microreactor is known, for example, from the abstract of the Japanese patent application No. 10337173 A. This document describes a microreactor which is formed by a plurality of independent chambers. These chambers are provided for a reaction of a fluid which can be passed via connections through the reaction chambers. Figure A of the document mentioned indicates that fluids can also be introduced via further inlets into the reaction chambers which are configured as channels, with mixing occurring in the reaction chamber.

It is an object of the invention to provide a microreactor which has a simple structure and enables the reaction in the reaction space to be controlled in a targeted way.

According to the invention, the object is achieved by catalyst particles for a desired reaction product being provided, with each catalyst particle being provided with a coupled-on partner and the coupled-on partners being bound to interaction partners which are in turn immobilized in the interior of the reaction space. Catalyst particles in this context are in the widest sense all configurations of means of influencing the reaction which occurs, whose smallest geometric units can bind to the interaction partners. It is possible to conceive of molecules, cells or inorganic composite molecules such as metal powders or salt crystals which slow the reaction, accelerate the reaction or make the reaction possible at all. The catalyst particles are bound to an interior surface of the reaction space, which is formed, in particular, by the interior wall of the microreactor, according to the principle which is adequately known for analytical methods by means of biochips. The immobilized interaction partners take on the function of a lock, with the coupling-on partners of the catalyst particles which are to be bound to the interaction partners acting as the keys. In this way, suitable catalyst particles can be fixed in defined places on the interior surface of the reaction space without the reaction chamber having to be opened. The only prerequisite for this is that the interaction partners necessary for this purpose have previously been immobilized in the reaction space.

An advantageous embodiment of the invention provides for the coupling-on partners and interaction partners to be in the form of complementary oligonucleotides. The catalyst particles can thus be bound by means of hybridization. Such a hybridization reaction can advantageously be reversed by simple heating of the interaction partners above a critical temperature, so that the catalyst in the reaction space can be changed readily. The microreactor can thus advantageously be used for carrying out different reactions without a great effort being expended for re-equipping it.

A further advantageous embodiment of the microreactor provides for it to be configured as a plug flow reactor. For the purposes of the present invention, a plug flow reactor is a microreactor having a channel-like structure whose cross section is chosen so that the fluid passed through it moves only in the longitudinal direction of the channel. This means that no reaction gradients occur over the cross section of the channel, so that each cross section of the fluid passed through the reaction channel is equivalent to a “plug” passed along the channel and always subjected to the same reaction profile. The plug flow reactor can thus advantageously provide a reaction profile which begins at the input of the plug flow reactor and ends at the outlet of the plug flow reactor.

In a further development of the plug flow reactor, different types of catalyst particles arranged in succession in the flow direction of the fluid are provided with different types of coupling-on partners and the coupling-on partners are bound to interaction partners which are in each case specifically matched to the coupling-on partners. In such a case, it is particularly advantageous for the interaction partners to be located in different, successive zones along the reaction channel, so that different types of catalyst particles can be bound to the interaction partners in each zone. In this way, a reaction which requires different catalysts in different reaction states to promote the reaction can be effected in the plug flow reactor. In this way, complex reaction sequences can also be carried out advantageously in the plug flow reactor, which is why this is particularly useful for “upstream processing” as preliminary reactor for discovering the advantageous parameters for a reaction process to be implemented on an industrial scale.

Another embodiment of the invention provides for a multiplicity of reaction spaces to be arranged as an array in the microreactor. This enables a high degree of parallelization to be achieved, as a result of which a plurality of reactions can advantageously be carried out simultaneously with slight modifications of the reaction parameters. The abovementioned upstream processing can be carried out very efficiently in this way by means of a high degree of parallelization, i.e. it can be carried out inexpensively and in a short time.

If an array of reaction spaces is used, it is advantageous for at least some of the reaction spaces to be fluidically connected to one another. In this way, the length of the reaction spaces available can advantageously be varied. In particular, as mentioned above, a combination of different catalyst particles can be achieved in the various reaction spaces which are connected to one another.

Furthermore, it is advantageous for at least one sensor for monitoring the desired reaction to be connected to the microreactor. In this way, the process carried out in the microreactor can be monitored or data relating to the process parameters can be collected, which advantageously makes it possible to obtain additional information on the events in the reaction. In the case of transparent reactor walls, monitoring can, for example, be carried out visually. Another possibility is the installation of microprobes in the reactor.

The invention further provides catalyst particles having a structure which influences a reaction. In this context, attention may be drawn to the generally known fact that catalysts influence various reactions essentially because of their structural makeup. Generally known catalyst particles are, for example, enzymes whose molecular structure makes possible, in particular, biochemical reactions occurring in living organisms.

It is an object of the present invention to indicate catalyst particles by means of which reactions in microreactors can be controlled in a comparatively simple fashion.

It has been found that this object is achieved by the structure of the catalyst particles being provided with a coupling-on partner for binding the catalyst particle to a fixed interaction partner. This coupling-on partner makes it possible, as mentioned above, to line the interior surface of a microreactor with the catalyst particles. For this purpose, interaction partners are immobilized on the inner surface of the reaction space to accommodate the catalyst particles. When used in a microreactor, the abovementioned advantages can therefore be achieved by means of the catalyst particles of the invention.

One embodiment of the present invention provides for the coupling-on partner to be formed by an oligonucleotide. Thus, oligonucleotides can be used as interaction partners so that the catalyst particles can be attached by means of a reversible hybridization reaction. The important advantage of this embodiment of the invention is the reversibility of the hybridization reaction, so that the catalyst particles can be removed again from the fixed interaction partners.

Further particulars of the invention are illustrated below with the aid of the drawing. In the drawing,

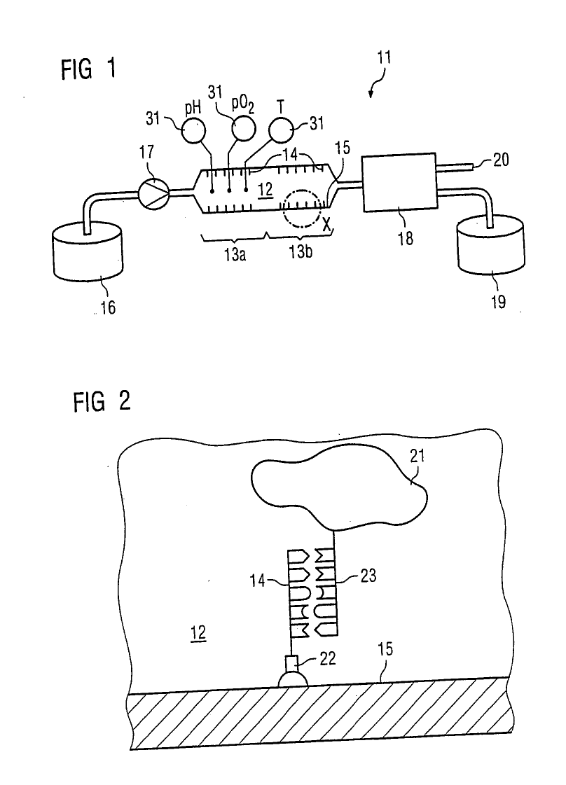

FIG. 1 schematically shows, by way of example, one embodiment of the microreactor of the invention,

FIG. 2 shows the detail X from FIG. 1,

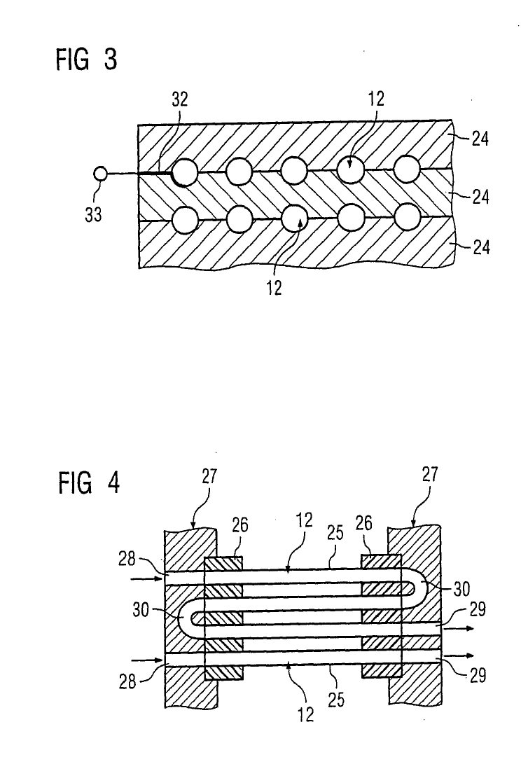

FIG. 3 shows part of an example of a reaction space of the reactor of the invention shown in section and

FIG. 4 schematically shows a longitudinal section of an array of reaction spaces in another embodiment of the reactor of the invention.

A microreactor 11 is provided with a channel-like reaction space 12 in which interaction partners 14 in the form of oligonucleotides of differing structure are immobilized on an interior reactor wall 15 in a first section 13a and in a second section 13b.

The total structure of the microreactor 11 can be deduced from the way in which it functions. It is used as follows for “upstream processing”. A reaction liquid is taken from a reservoir 16 and fed by means of a pump 17 into the reaction chamber 12 which functions according to the plug flow principle. Here, the reaction liquid flows firstly through the first section 13a in which a first catalyst is employed and subsequently through the section 13b in which the reaction is promoted by another catalyst. The test liquid then leaves the reaction space and enters an analysis module 18 which is not shown in further detail. Here, data regarding the reaction product can be collected and these can be utilized for optimizing the process to be examined. After analysis, the reaction liquid goes to a waste container 19, or any reaction products can be passed to a further use via an outlet branch 20.

FIG. 2 shows in greater detail the way in which a catalyst particle 21 is bound to the interior wall 15 of the reactor. The interaction partner 14, which comprises an oligonucleotide (i.e. DNA, RNA or PNA), is immobilized on the interior wall 15 of the reactor by means of generally known coupling chemistry 22. The catalyst particle 21 has a structure which is not shown in more detail but is suitable for influencing a particular reaction. Furthermore, this structure is provided with a coupling-on partner 23 in the form of an oligonucleotide corresponding to the interaction partner 14, so that the catalyst particle 21 can be bound to the interior wall 15 of the reactor via the two oligonucleotides.

The catalyst particle 21 can, for example, be a cell which, due to its function, participates in a biochemical reaction. An oligonucleotide can readily be bound as coupling-on partner to a cell. However, such bonding can also be achieved by means of suitable coupling chemistry (addressed above) to an inorganic substance. Furthermore, it is also conceivable for the coupling-on partner 23 itself to be part of a longer nucleotide chain which simultaneously takes on the function of catalyst. In this embodiment, the coupling-on partner 23 itself does not, however, participate in the catalytic action, since it is hybridized with the interaction partner 14.

FIG. 3 shows a part section through a possible construction of a microreactor in which an array of reaction spaces 12 is provided. This is formed by structuring of the surface of a plurality of substrates 24 and subsequent joining of the substrates, for example by adhesive bonding. In this way, channel-like reaction spaces are formed in the joins between the individual substrates.

FIG. 4 shows another embodiment of a reactor having an array of reaction spaces 12. These are formed by a bundle of glass tubes 25 whose ends have been embedded in plastic supports 26. As shown schematically, the plastic supports 26 are suitable for accommodating connection pieces 27 which are part of a reactor which is not shown. Inlets 28 and outlets 29 for the reaction fluid can be provided in these connection pieces. In addition, individual glass tubes 25 can be connected to form a single reaction space by means of connecting channels 30. Connection of three glass tubes in series is shown, but parallel connection is also possible if this is beneficial for a reaction to be carried out.

It can also be seen from FIGS. 1 and 3 how the reaction spaces 12 can be equipped with sensors for monitoring the reaction which occurs. In FIG. 1, sensors configured as microprobes 31 are shown; these are, as indicated, provided for measurement of the pH, the oxygen content (pO₂) and the temperature (T). To obtain information on the reaction dynamics, it is possible, for example, for further microprobes for measuring the parameters mentioned to be provided in section 136 further along the reaction space (not shown) Furthermore, an electrode 32 for measuring the conductivity of the reaction fluid is shown in FIG. 3. In the construction of the reaction spaces shown in FIG. 3 (stack of substrates), this can be produced by metallic coatings which are located in the joins between substrates and are provided externally with a contact 33.

1. A microreactor (11) having a reaction space (12) for a fluid comprising at least one reactant, wherein catalyst particles (21) for a desired reaction product are provided and each catalyst particle is bound by means of a coupling-on partner (23) to interaction partners (14) which are in turn immobilized in the interior of the reaction space (12).

2. A microreactor as claimed in claim 1, wherein the coupling-on partners (23) and the interaction partners (14) are in the form of complementary oligonucleotides.

3. A microreactor as claimed in claim 1, wherein it is configured as a plug flow reactor.

4. A microreactor as claimed in claim 3, wherein different types of catalyst particles (21) arranged in succession in the flow direction of the fluid are provided with different types of coupling-on partners (23) and the coupling-on partners (23) are bound to interaction partners which are in each case specifically matched to the coupling-on partners (23).

5. A microreactor as claimed in claim 1, wherein a multiplicity of reaction spaces (12) are arranged as an array in the microreactor.

6. A microreactor as claimed in claim 5, wherein at least some of the reaction spaces (12) are fluidically connected to one another.

7. A microreactor as claimed in claim 1, wherein the microreactor is provided with at least one spacer (31,32) for monitoring the desired reaction.

8. A catalyst particle having a structure which influences a reaction, wherein this structure is provided with a coupling-on partner (23) for binding the catalyst particle to a fixed interaction partner.

9. A catalyst particle as claimed in claim 8, wherein the coupling-on partner (23) is formed by an oligonucleotide.

10. A microreactor as claimed in claim 2, wherein it is configured as a plug flow reactor.

11. A microreactor as claimed in claim 2, wherein a multiplicity of reaction spaces (12) are arranged as an array in the microreactor.

12. A microreactor as claimed in claim 3, wherein a multiplicity of reaction spaces (12) are arranged as an array in the microreactor.

13. A microreactor as claimed in claim 4, wherein a multiplicity of reaction spaces (12) are arranged as an array in the microreactor.

14. A microreactor as claimed in claim 2, wherein the microreactor is provided with at least one spacer (31,32) for monitoring the desired reaction.

15. A microreactor as claimed in claim 3, wherein the microreactor is provided with at least one spacer (31,32) for monitoring the desired reaction.

16. A microreactor as claimed in claim 4, wherein the microreactor is provided with at least one spacer (31,32) for monitoring the desired reaction.

17. A microreactor as claimed in claim 5, wherein the microreactor is provided with at least one spacer (31,32) for monitoring the desired reaction.

18. A microreactor as claimed in claim 6, wherein the microreactor is provided with at least one spacer (31,32) for monitoring the desired reaction.
